(19) United States
(12) Patent Application Publication
(10) Pub. No.: US 2013/0288198 A1
(43) Pub. Date: Oct. 31, 2013

(54) HEALING ABUTMENT AND FINAL ABUTMENT FOR USE WITH DENTAL IMPLANT

(71) Applicant: RYAN EDWARD ROBERTS, Englewood, FL (US)

(72) Inventor: RYAN EDWARD ROBERTS, Englewood, FL (US)

(21) Appl. No.: 13/457,672

(22) Filed: Apr. 27, 2012

(51) Int. Cl. A61C 8/00

(52) U.S. Cl. 433/173

(57) ABSTRACT

Systems and methods of controlling an abutment when inserting or removing the abutment are disclosed. An improved dental abutment is presented that includes a tunnel whereby dental floss may be laced through to serve as a tether for retrieval of the abutment during attachment to or removal from a dental implant.

### BACKGROUND OF THE INVENTION

During the insertion and removal of a healing abutment, as well as the insertion of a final abutment, great care is stressed amongst dentists and oral surgeons to not allow the abutment to fall free from their control into the patient's throat and result in complications for the patient.

One serious potential complication when an abutment falls free is asphyxiation, where the fallen abutment prevents the patient from breathing. Another potential complication from a fallen abutment is aspiration of the abutment by the patient; where instead of blocking the patient's airway, the abutment enters the patient's lungs. Yet another potential complication from a fallen abutment is when a patient swallows the abutment and the abutment enters the digestive tract, potentially causing digestive complications.

Even with these and other potential complications due to fallen abutments, current healing abutments and final abutments are not configured for easy control and retrieval should the abutment fall from the dentist's control during insertion or removal. Indeed, for each of the current methods by which a dentist may choose to insert or remove an abutment, even those designed for the improved control or grasp of the abutment, the possibility remains for the abutment to fall free from the dentist's control and not be easily retrievable.

For example, one preventative measure known in the art is to insert sterile gauze at the base of the patient's mouth prior to and during the insertion or removal of an abutment to help prevent the abutment from entering the pharynx should the abutment fall free; commonly referred to as a “throat pack”. This practice is often uncomfortable or bothersome for the patient. In addition, if the gauze of the throat pack is not properly positioned at the back of the mouth the opportunity remains for the abutment to pass under or around the gauze placing the patient at risk for severe complications including asphyxiation. It can also be awkward for the dentist to attempt to retrieve an abutment after it has landed on the gauze. The act of attempting to retrieve an abutment from the gauze provides additional opportunities for the abutment to fall free. Moreover, use of gauze can further reduce the available work space for the dentist during the procedure.

Accordingly, there is a need in the art for an improved preventative measure during the insertion and removal of abutments.

### BRIEF SUMMARY

The present disclosure is directed to an improved abutment and method for quickly and easily retrieving a healing abutment or final abutment should it fall free during the insertion or removal process.

According to one embodiment of the invention, a tunnel is provided on the face of a healing abutment whereby dental floss (or other sterile thread) may be laced through to serve as a tether to the healing abutment.

According to another embodiment of the invention, a tunnel is provided on, or through, an area of a final abutment whereby dental floss (or other sterile thread) may be laced through to serve as a tether to the final abutment.

In accordance with certain embodiments, a method is provided for enabling easy retrieval and control of abutments during surgery by using a tether laced through an abutment having a tunnel therein. By using an abutment and tether in accordance with various embodiments of the invention, a dental professional can safely insert and remove abutments with minimal training or the use of specialized tools.

Certain embodiments of the invention provide for increased patient safety during the insertion or removal of dental abutments. While care is still paramount during insertion and removal of an abutment, having a floss tether attached to the abutment allows the dentist to proceed with increased confidence.

### BRIEF DESCRIPTION OF THE DRAWINGS

FIG. 1 shows an anatomical cross-section drawing of a healing abutment attached to a root-form endosseous implant in accordance with an embodiment of the invention; tunnel not shown.

FIGS. 2A-2C show a healing abutment with both entry/exit holes of the tunnel on the face of the healing abutment in accordance with certain embodiments of the invention. FIGS. 2A and 2B show top views and FIG. 2C shows a side view.

FIGS. 3A-3D show a healing abutment with one entry/exit hole of the tunnel on a face of the healing abutment and the other entry/exit hole on an interior of a recessed portion of the healing abutment head. FIGS. 3A and 3B show a top view and side view, respectively, of an abutment having one tunnel in accordance with an embodiment of the invention. FIGS. 3C and 3D show a top view and a side view, respectively, of an abutment having two tunnels in accordance with an embodiment of the invention.

FIGS. 4A-4C show photographs of a prototype healing abutment with tunnel and dental floss tether as viewed from the side (FIG. 4A) and from an above angle (FIG. 4B); FIG. 4C shows the prototype healing abutment next to a dime for reference of scale.

FIG. 5 shows an anatomical cross-section drawing of a final abutment attached to a root-form endosseous implant with a cemented crown in accordance with an embodiment of the invention; tunnel not shown.

FIGS. 6A-6B show a side view and top view, respectively, of a final abutment of certain embodiments of the invention.

FIGS. 7A-7B show a side view and top view, respectively, of a final abutment with both entry/exit holes of the tunnel on the perimeter of the supra-gingival head of the final abutment according to an embodiment of the invention.

FIGS. 8A-8D show examples of a final abutment with tunnel where at least one hole is located on the perimeter surface of the supra-gingival head and at least one other hole is located on the wall of the longitudinal hollowed portion. FIGS. 8A-8B show a side view and top view, respectively, of an abutment where one hole is located on the perimeter and the other hole is located on the wall of the longitudinal hollowed portion. FIGS. 8C-8D show a side view and top view, respectively, of an abutment with two tunnels where two holes are located on the perimeter and two holes are located on the wall of the longitudinal hollowed portion.

FIGS. 8E-8F show a side view and top view, respectively, of an inverted example of a final abutment with two holes located on the perimeter and two holes located on the wall of the longitudinal hollowed portion, with a floss tether tied to inhibit the abutment screw from dislodging from the abutment.

### DETAILED DISCLOSURE

Embodiments of the invention provide methods and devices for improved dental healing abutments and final abutments for use with dental implants.

Certain embodiments of the invention enable a dentist to improve the handling of an abutment during insertion and removal even with the challenges presented by the inherent environment of a patient's mouth.

In particular, a patient's mouth is a confined workspace for a dentist and provides a dentist limited access when the dentist is inserting or removing an abutment. The amount of space available in which a dentist may work (e.g., access) is largely dictated by how far the patient's mandible (lower jaw) can open, as well as the size and shape of the patient's palate (roof of the mouth). Access is especially restricted in the back region of the mouth, approaching the temporomandibular joint where the molars are located. The restricted region provides not only limited work space, but also a limited line of sight and limited access to light. Small handheld mirrors and lighting instruments may be used; however, the addition of these instruments may further decrease the available work space.

In addition to working within a confined workspace, a dentist may experience unexpected movement on the part of the patient. A patient typically does not require anesthesia during the insertion or removal of an abutment except for localized anesthesia and, thus, is conscious during the procedure. The unexpected movement of a patient's tongue or jaw, either involuntarily or in an attempt to communicate, can cause interference in the form of bumping the dentist's hand, tool, or even the abutment itself. Coughing, sneezing, or yawning by the patient creates unexpected movements of the jaw, mouth, head, and/or neck, as well as unexpected air movements. These actions provide interference with the dentist's control of the abutment or tool used therewith. Finally, jaw movement or closure due to patient fatigue and/or discomfort further restricts the available working space and provides interference to the dentist's control

In order to address these challenges, certain embodiments provide a system in which the abutment can be retained during unexpected movement by the patient while minimizing the encroaching impact to the available workspace.

In accordance with one embodiment of the invention, dental abutments, including healing abutments and final abutments, are provided that include a tunnel configured to receive dental floss that may be laced through to be used as a tether.

In accordance with another embodiment of the invention, methods are provided for performing insertion and removal of dental abutments. In one such embodiment, a dental abutment is provided that includes a tunnel configured to receive dental floss; and dental floss is laced through the tunnel, the dental floss having a length such that excess length of floss is available after lacing the floss through the tunnel. In a further embodiment, after lacing the floss through the tunnel, the excess length of floss is then tied or knotted.

In accordance with yet another embodiment of the invention, systems for performing insertion and removal of dental abutments are provided. In one such embodiment, a system is provided that includes a dental abutment having a tunnel; and a tether releasably attached via the tunnel. In a specific embodiment, the tether is provided by floss laced through the tunnel.

Various implementations of embodiments of the invention provide for increased patient safety during the insertion or removal of dental abutments. In addition, both the patient and dentist may experience increased psychological comfort with the knowledge of reduced risk during the procedure. While care is still paramount during insertion and removal of an abutment, having a tether attached to the abutment allows the dentist to proceed with increased confidence. By providing increased confidence, a dentist can work at an increased pace without apprehension of the potential consequences of losing control of the abutment. This may result in decreasing the length of time for dental procedures.

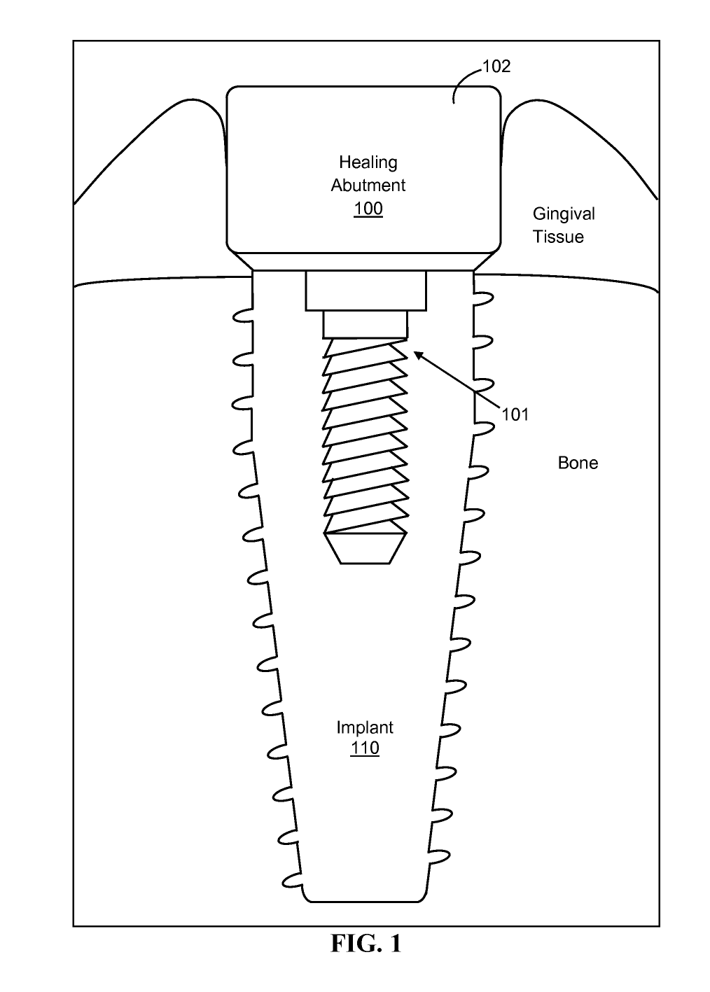

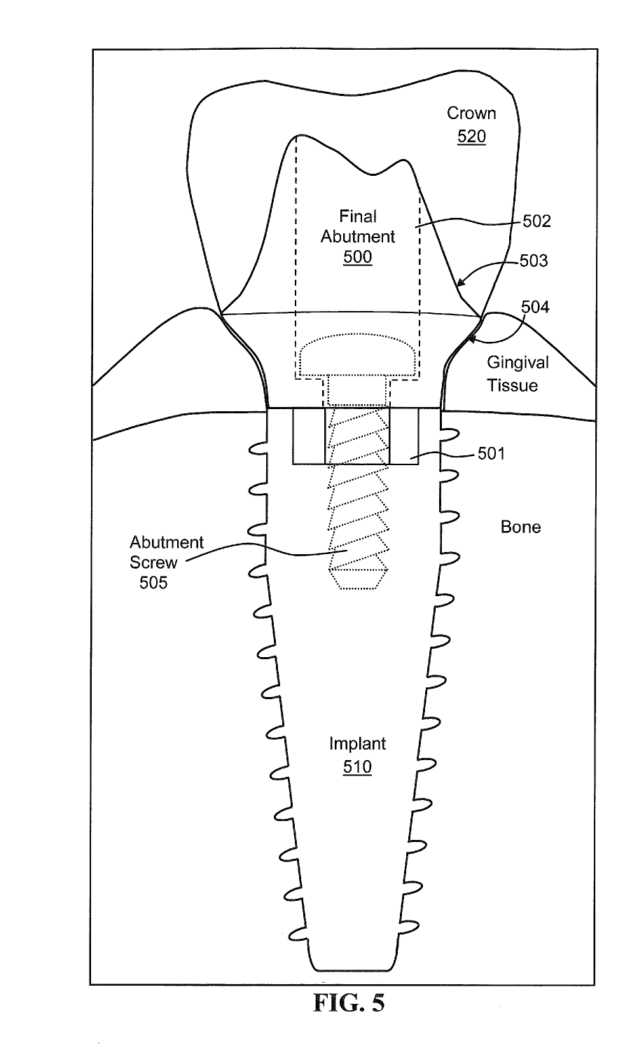

Embodiments of the subject methods, systems, and abutments can be used for dental implant surgery. In one embodiment, the implant of the dental implant surgery is a root-form endosseous implant. A root-form endosseous implant is typically metal, often titanium, and shaped in a threaded hollow screw-like formation such as shown in FIGS. 1 and 5. To prepare for an implant, a hole or incision is made through the patient's gingival tissue (commonly referred to as “gums”) to expose the patient's jaw bone, and a hole is further drilled through the exposed jaw bone (maxilla or mandible). Then, the implant is inserted into the jaw bone during a first stage of dental implant surgery. A healing stage follows the first stage of the dental implant surgery and once healing occurs, the dental implant surgery may conclude with the insertion of a final abutment and the eventual attachment of a crown, bridge, fixed partial denture, or other final prosthesis (not illustrated herein) that is supported by the implant.

A healing abutment is used to facilitate the healing stage following implant surgery in order for the jaw bone and dental implant to fuse by a natural process of osseointegration. During the healing stage, the gingival tissue heals relative to the healing abutment. At the dentist's discretion, either a two-stage or one-stage technique for inserting the healing abutment may be used. In a two-stage technique, the gingival tissue is sutured to heal over the implant after insertion into the jaw bone as part of a first stage. Then in a second stage (at a subsequent appointment several weeks or months later), the gingiva is reopened to expose the top of the implant for inspection by the dentist to confirm osseointegration of the implant and the healing abutment is then attached to the implant. In the one-stage technique, the healing abutment is inserted into the implant directly following the insertion of the implant into a patient's jaw bone.

Healing abutments may be inserted or removed from a dental implant by a variety of methods. Examples include: manually held by the dentist's fingertips; manually with the abutment held within a clip or housing for the abutment; the use of a driver, which may include a hex, star, square, or other shaped driver wherein a recessed shape on the abutment directly corresponds with an appropriately shaped driver shaft; the use of a driver including a retention mechanism, or the use of a tweezers-like device to grip the abutment.

The healing abutment may be handled by the dentist several times before the final abutment is attached to the dental implant. Each time an abutment is inserted or removed from the implant (or an attempt is made) presents a new opportunity for the abutment to fall from the dentist's control and jeopardize the patient's safety.

As illustrated in FIG. 1, a healing abutment 100 in accordance with various embodiments of the invention includes a post 101 and a head 102. The post portion 101 of the healing abutment attaches to a dental implant 110. The post 101 illustrated in FIG. 1 is threaded for screwing into a dental implant 110 (a root-form endosseous implant is shown). Of course, embodiments are not limited to the screw attachment, threaded-style post. The “head” of the abutment refers to the portion of the abutment around which the gingival tissue heals. The head fills the void between the implant and the gingiva. A well placed and appropriately sized healing abutment head will maintain the shape and contours of gingival tissue to allow final abutment placement, and will project slightly beyond the gingival plane in order to inhibit the gums from healing over the abutment. The shape of the head may be cylindrical in nature, which is especially evident in stock healing abutments. However, the shape of a healing abutment head can vary greatly for custom healing abutments and it is contemplated that the shape of the abutments head is not limited to generally cylindrical shapes. Indeed, embodiments of the invention are contemplated as being implemented for any style abutment. For example, the healing abutment selected by a dentist can be determined by the size needed to maintain the appropriate shape and contour of gingival tissue during the healing process. Accordingly, the circumference of a healing abutment head to replace a molar will be larger than a healing abutment chosen to replace an incisor.

In various embodiments, the circumference measurements of the head, moving from the coronal end to the gingival end (where the head meets the post), may not be equal. The size and shape of the head depends on the dentist's expectations and/or desires of how the gingiva should heal relative to the implant.

The “face” of an abutment refers to the occlusal or incisal plane of the head. In accordance with various embodiments of the invention, the abutment face may be flat, domed, or taper into a plateau. The center of the face of the head (not shown in the side view of FIG. 1) can be recessed and shaped to receive a corresponding driver bit, e.g. a hexagonal shaped recession for use with a hex-driver.

As shown in FIG. 5, a final abutment 500 in accordance with various embodiments of the invention may include a hollow non-threaded post 501. The final abutment often does not contain a threaded shaft as is present on a healing abutment. Instead, the final abutment provides a longitudinal hole 502 through its center to allow an abutment screw 505 to pass through for attaching the final abutment to the dental implant 510. This type of connection can be referred to as an “internal connection.” External connections may also be used where the abutment receives a protrusion from an implant.

The final abutment head includes a coronal end 503 and an apical end 504. The coronal end of the final abutment head, also referred to as the “supra-gingival” (that which extends above the gum line), varies widely in size and shape. The selected size and shape for the coronal end 503 of the final abutment head depends both on the tooth being replaced by prosthesis and that which will result in a natural aesthetic and functionality. Strides have been made in the art to create a wide variety of custom sizes and shapes designed to maximize natural aesthetics and function.

The apical end 504 of the final abutment head, referred to as the “sub-gingival” (that which is below the gum line), is generally a smooth tapered region which fills the gingival socket. The point where the supra-gingival and sub-gingival intersect is generally the widest circumference of the final abutment.

The supra-gingival portion of the final abutment may taper into a conical shape to allow for the crown 520 and cement used therewith to fully encapsulate the coronal end 503 of the final abutment. However, as indicated above, final abutment head shapes vary widely and may include, but are not limited to, conical, cylindrical, curvilinear, or multi-angular shapes.

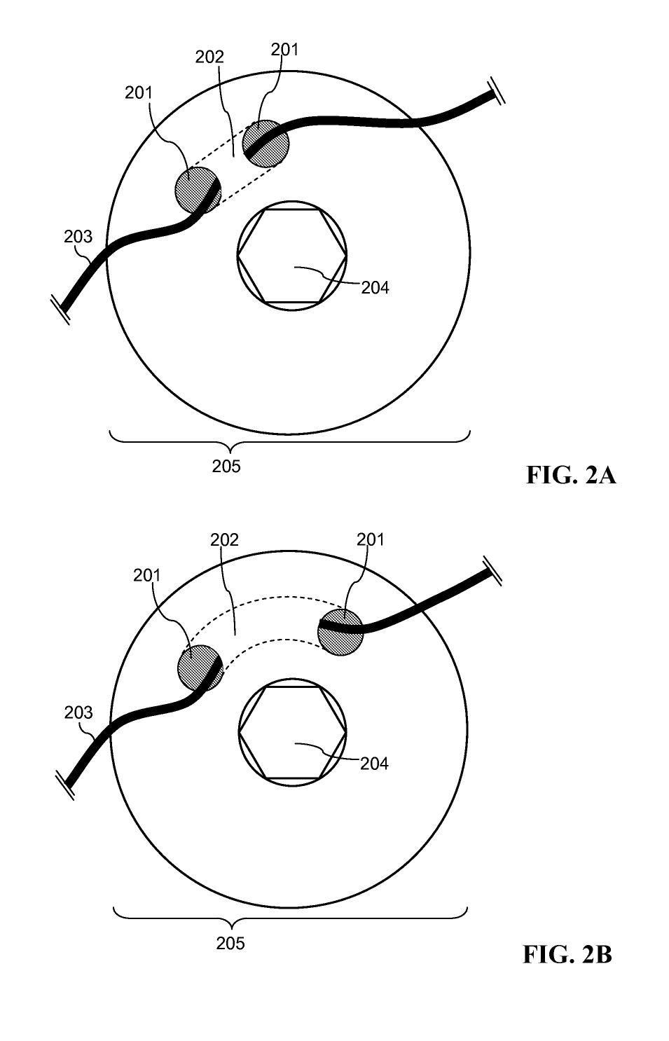

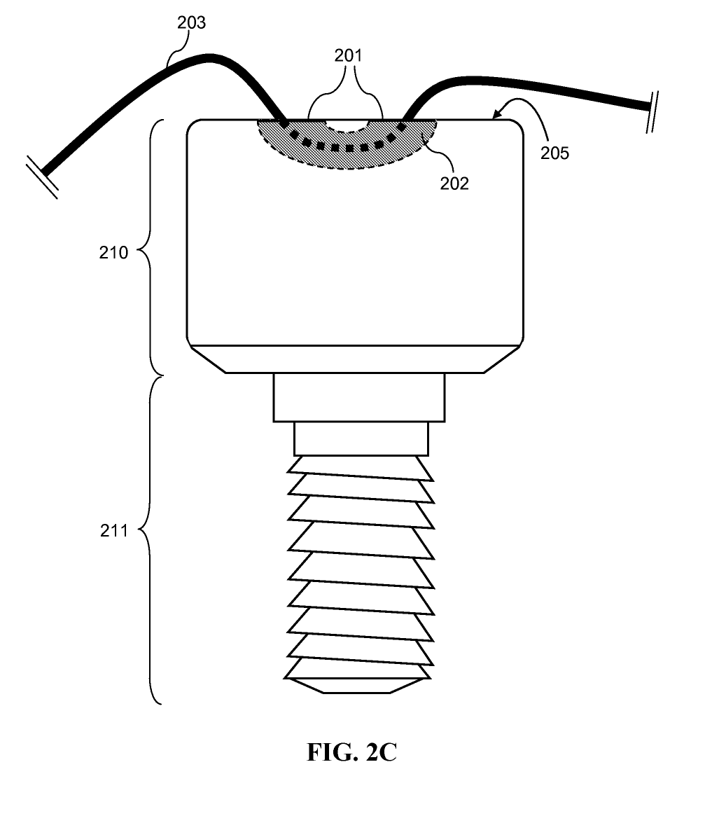

FIGS. 2A-2C show a healing abutment having a tunnel 202 with entry and exit holes 201 both on the face 205 of the healing abutment in accordance with an embodiment of the invention. FIGS. 2A and 2B show top views at the face of the abutment of in accordance with certain embodiments and FIG. 2C shows a side view indicating the tunnel 202 in accordance with an embodiment of the invention.

As explained with respect to FIG. 1, the healing abutment with tunnel 202, as shown in FIG. 2, includes a post 211 and a head 210. The head 210 of the healing abutment is more or less cylindrical in shape (though not limited to) with a smooth surface to facilitate the gingival healing. The abutment face 205 may be flat, domed, or taper into a plateau. Alternatively, the face 205 can have custom or more organic shape. A recess 204 can extend through the head 210 from the center of the face 205. The recess 204 can be shaped to receive a driver bit, e.g. a hexagonal shaped recession for use with a hex-driver. The post 211 can be attached, or screwed into (for use with a root-form endosseous implant), a dental implant 110 as shown in FIG. 1.

For the embodiments illustrated in FIGS. 2A-2C, a tunnel 202 is provided through the face 205 and into the head 210 of the healing abutment where entry/exit holes 201 of the tunnel 202 are both positioned on the face 205 of the healing abutment. The entry/exit holes 201 of the tunnel 202 are disposed so as to not be blocked by a patient's gingival tissue at any time during the healing stage.

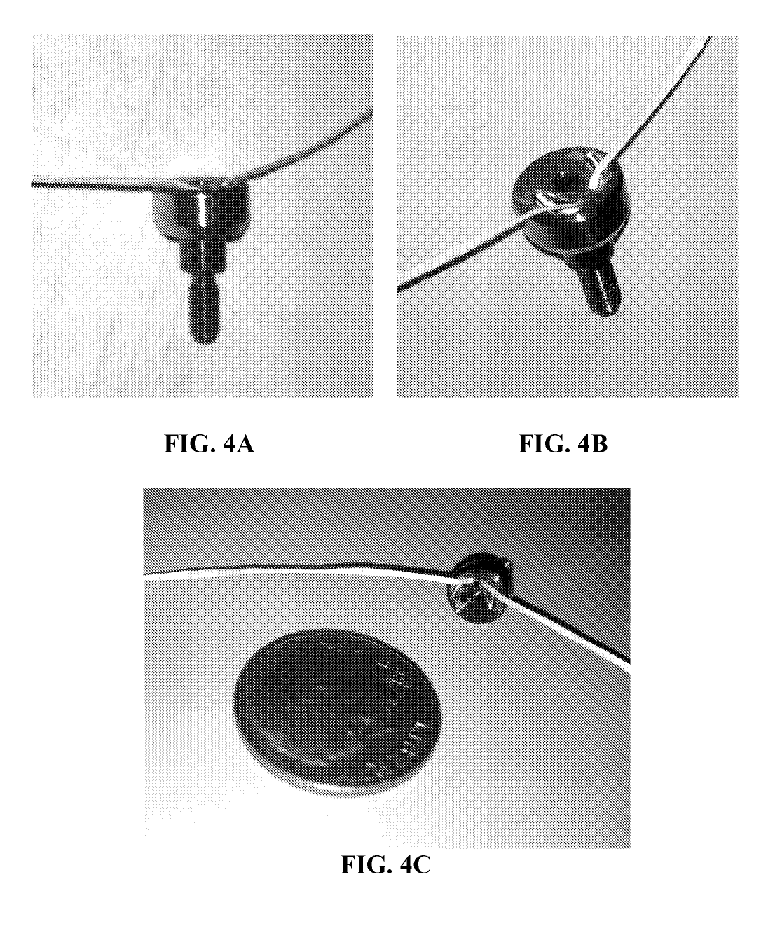

Although the entry/exit holes 201 are shown having a circular shape, embodiments are not limited thereto. In addition, the shape and curvature of the tunnel 202 is not limited and may be implemented in any direction as appropriate for the shape of the healing abutment. As shown in FIG. 2A the tunnel 202 can take the form of a relatively straight line (in plan view) between the entry/exit holes 201. In another embodiment, such as shown in FIG. 2B, the tunnel 202 can follow curvature (in plan view) of the head 210. The diameter or width of the tunnel 202 may be a different diameter than the entry/exit holes 201 and the entry/exit holes 201 can have different diameters (see FIG. 4B example with entry and exit holes being larger than the tunnel itself).

The tunnel 202 provides for dental floss 203 to be laced through to serve as a tether. As indicated above, this tether may be used to retrieve the healing abutment from the patient's mouth or throat should the healing abutment fall free from the dentist's control during the insertion or removal of the healing abutment.

When lacing the floss through the tunnel 202, an excess length of floss is to be used as the tether for easy access to grasp if the healing abutment falls free. In a further embodiment when using an abutment in accordance with embodiments of the invention, the floss is also tied or knotted. Tying-off the floss tether reduces the risk of the floss coming out of the tunnel when the tether is pulled during retrieval of the fallen abutment (knotted healing abutment not illustrated).

The diameter of the tunnel hole can be limited by the size and thickness of the abutment head from its outer circumference to the perimeter of the recess within the abutment head.

However, the entry and exit holes of the tunnel can be widened to provide for a greater area by which the floss 203 may enter the tunnel 202. In addition, with a larger entry/exit hole, a dental professional has a larger area to access and take hold of the floss 203 as it exits the tunnel 202 with or without the use of a floss threader. By providing easier access to fully lace the floss 203 through the healing abutment, the lacing process can be made faster.

In a preferred embodiment, the tunnel 202 of the healing abutment is smooth and relatively shallow to avoid obstructing the movement of the floss 203 during the lacing process. In instances where the tunnel 202 is partially or fully blocked after residing in the patient's mouth due to plaque, food, etc., it may be recommended that the tunnel 202 first be cleared using a dental air/water syringe tip apparatus as to not impede the movement of the floss 203 through the tunnel 202 during the lacing process.

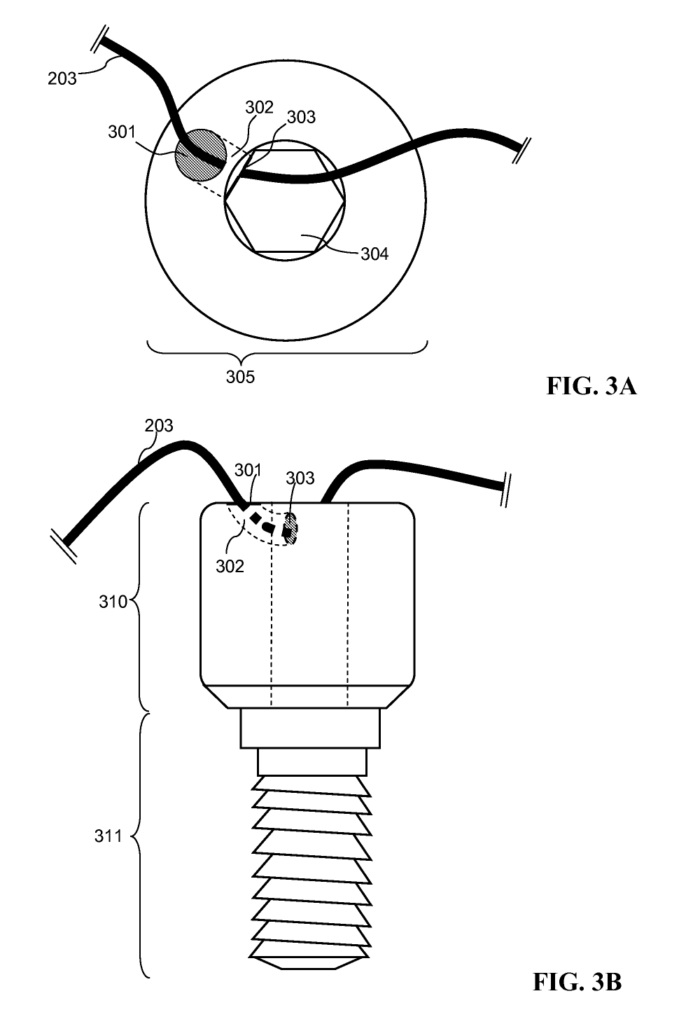

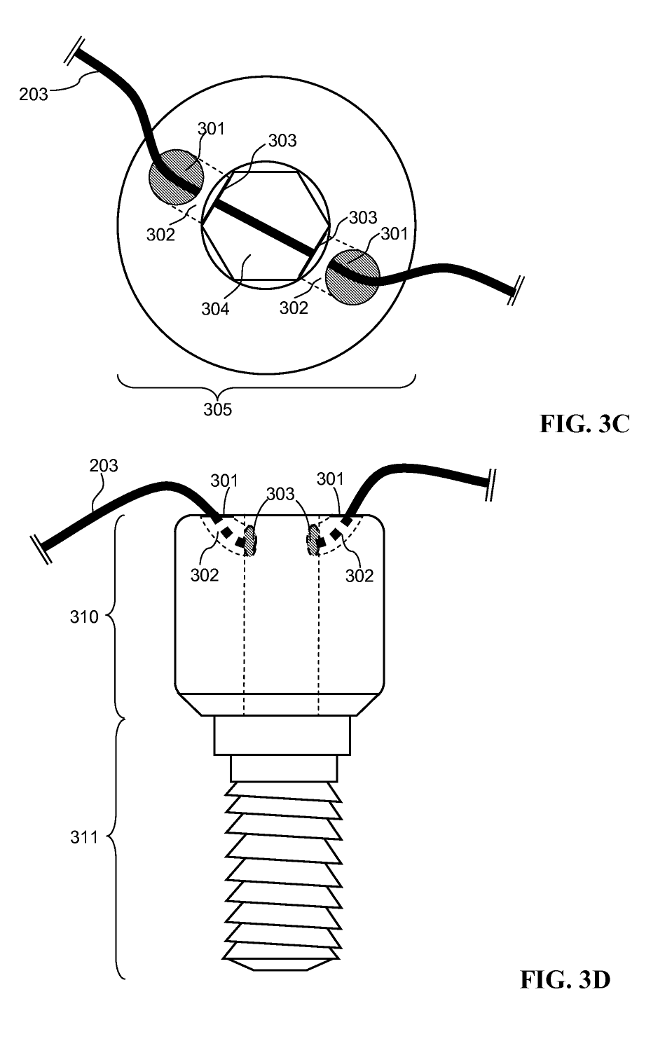

FIGS. 3A-3D show a healing abutment having at least one tunnel 302 with one entry/exit hole 301 on the face 305 of the healing abutment and one entry/exit hole 303 on an interior of the recess portion 304 of the head 310. FIGS. 3A and 3B show a top view and side view, respectively, of an abutment having one tunnel 302 in accordance with an embodiment of the invention. FIGS. 3C and 3D show a top view and a side view, respectively, of an abutment having two tunnels 302 in accordance with an embodiment of the invention. For the embodiment illustrated in FIGS. 3C and 3D, the two tunnels 302 can be considered to be a single tunnel that spans across the recess 304 between the entry/exit holes 303 on the interior of the recess 304 when lacing the floss through the tunnels 302.

The post 311, head 310, and face 305 of the healing abutments shown in FIGS. 3A-3D can be implemented in a variety of shapes, sizes and configurations as described above with respect to FIGS. 1 and 2A-2C and so a detailed explanation is not repeated here.

Although the entry/exit holes 301, 303 are shown having a circular shape, embodiments are not limited thereto. In addition, the shape and curvature of the tunnel 302 is not limited and may be implemented in any direction as appropriate for the shape of the healing abutment. The diameter or width of the tunnel 302 may be a different diameter than the entry/exit holes 301, 303 and the entry/exit holes 301, 303 can have different diameters.

The entry/exit holes 301, 303 of the tunnel 302 can be widened to provide for a greater area by which the floss 203 may enter the tunnel 302. In addition, with a larger entry/exit hole, a dental professional has a larger area to access and take hold of the floss 203 as it exits the tunnel 202 with or without the use of a floss threader. By providing easier access to fully lace the floss 203 through the healing abutment, the lacing process can be made faster.

The tunnel 302 provides for dental floss 203 to be laced through to serve as a tether. As indicated above, this tether may be used to retrieve the healing abutment from the patient's mouth or throat should the healing abutment fall free from the dentist's control during the insertion or removal of the healing abutment.

Use of the recess area 304 for one (or more) of the holes 303, such as shown in FIGS. 3A-3D, provides a more direct angle by which to lace the floss through the entry/exit holes 301, 303. The use of the arrangement as illustrated in FIGS. 3A-3D can be preferred, for example, in instances of small or narrow healing abutments where there is less available space to place both entry/exit holes on the face 305 of the healing abutment.

When lacing the floss through the tunnel 302, an excess length of floss is to be used as the tether for easy access to grasp if the healing abutment falls free. In a further embodiment when using an abutment in accordance with embodiments of the invention, the floss is also tied or knotted. Tying-off the floss tether reduces the risk of the floss coming out of the tunnel when the tether is pulled during retrieval of the fallen abutment (knotted healing abutment not illustrated).

In instances where the tunnel 302 is partially or fully blocked after residing in the patient's mouth due to plaque, food, etc., it may be recommended that the tunnel 302 first be cleared using a dental air/water syringe tip apparatus as to not impede the movement of the floss 303 through the tunnel 302 during the lacing process.

The healing abutments with tunnel as described herein may be fabricated by a variety of means, including by casting or milling; and the tunnel may be formed at the same time as the healing abutment, or added by modifying a previously fabricated healing abutment.

As mentioned above, in addition to healing abutments, final abutments can be provided with tunnels for enabling better control of the abutments during insertion and removal.

A final abutment may be designed to be covered by a crown, as illustrated in FIG. 5, or by an attached bridge, fixed partial denture, or other final prosthesis designed for long term use (not illustrated herein).

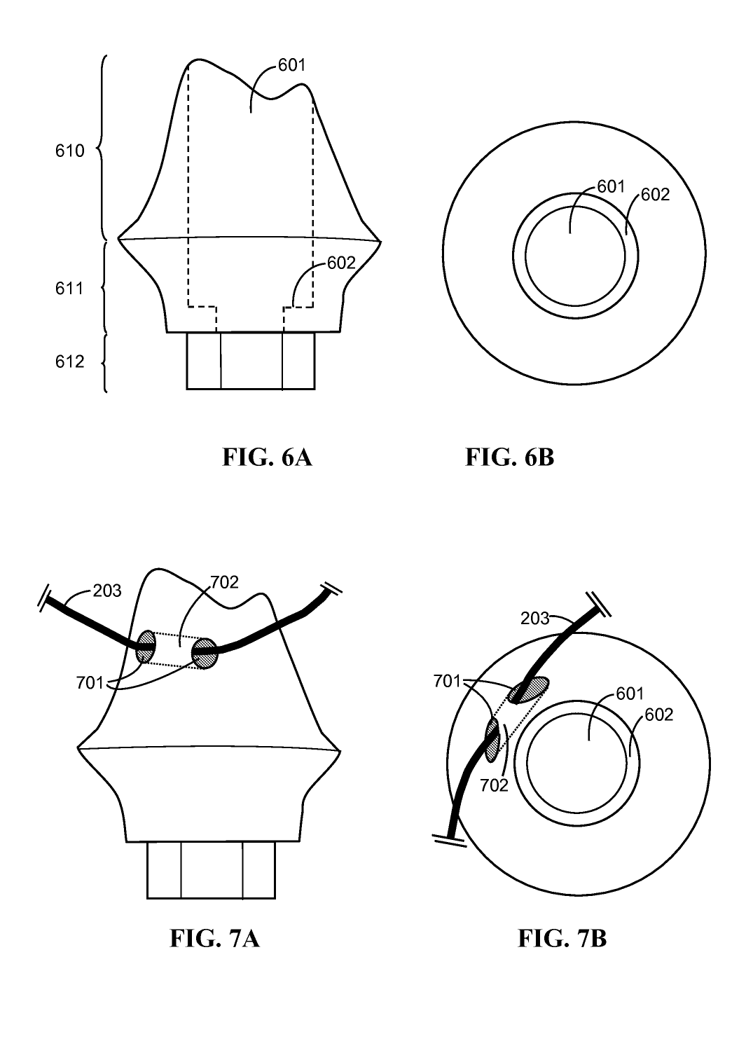

As described above with respect to FIG. 5 and shown in the custom final abutment illustrated in FIGS. 6A and 6B, a final abutment head can be considered to be composed of two sections. The coronal end of the final abutment head can be referred to as the “supra-gingival” 610 (that which primarily extends above the gum line); and the apical end of the final abutment head can be referred to as the “sub-gingival” 611 (that which is below the gum line).

A final abutment includes a hollow non-threaded post 612 (see also 501 of FIG. 5). The final abutment post 612 is shaped (e.g. having a hexagonal or other cross-section) to correspond to an aperture in the implant. When the post is set into the aperture of the implant, the shapes align and inhibit the implant from shifting position. A final abutment also provides a longitudinal hole 601 through its center to allow an abutment screw 505 to pass through. The longitudinal hole 601 can have a wider diameter at a top portion that at a bottom portion in order to provide a shelf 602 on which a head of the abutment screw 505 can rest. The abutment screw 505 is used to attach the final abutment to a dental implant 510 such as shown in FIG. 5.

FIGS. 7A and 7B show a final abutment having a tunnel 702 with entry and exit holes 701 both on the outer surface of the supra-gingival portion 610 of the final abutment (hereafter referred to as the “face of the supra-gingival area”) in accordance with an embodiment of the invention. FIG. 7A shows a side view and FIG. 7B shows a top view of a final abutment having a tunnel 702 in accordance with certain embodiments.

The tunnel 702 provides a means for dental floss 203 to be laced through to serve as a tether. As indicated above, this tether may be used to retrieve the final abutment from the patient should the final abutment fall free from the dentist's control while the placing the final abutment into the implant 510.

When lacing the floss through the tunnel 702, an excess length of floss is to be used as the tether for easy access to grasp if the final abutment falls free. In a further embodiment when using an abutment in accordance with embodiments of the invention, the floss is also tied or knotted. Tying-off the floss tether reduces the risk of the floss coming out of the tunnel when the tether is pulled during retrieval of the fallen abutment.

As indicated in FIGS. 7A and 7B, the tunnel 702 may be positioned through the final abutment whereby both of the entry/exit holes 701 of the tunnel 702 are located on the perimeter or face of the supra-gingival area of the final abutment 610.

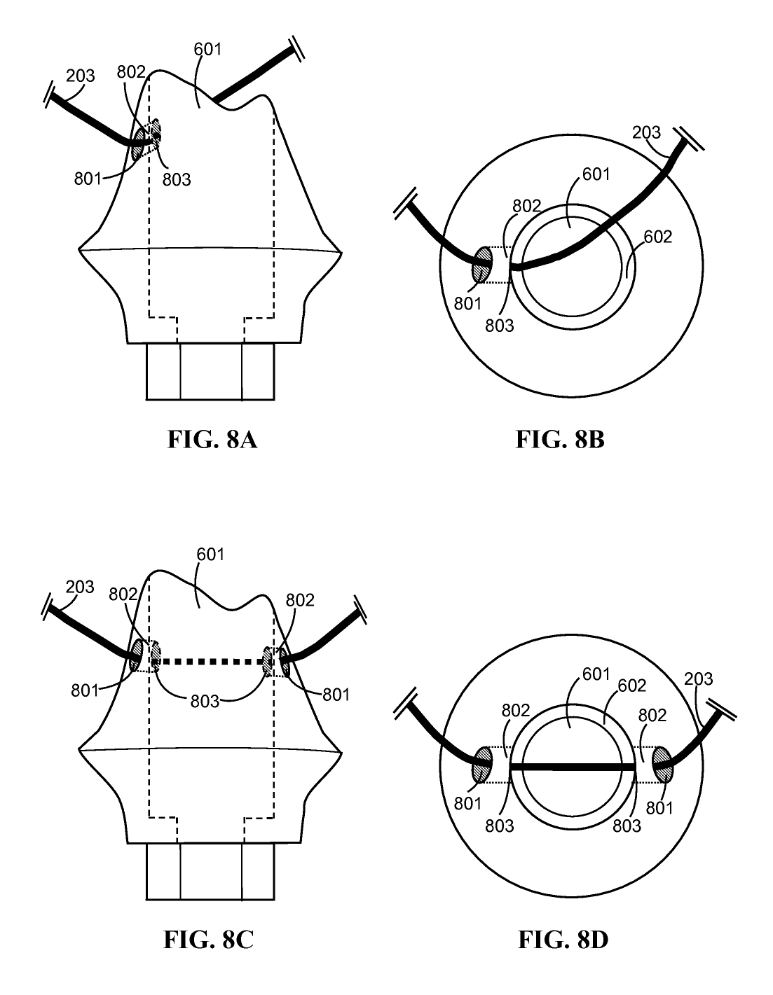

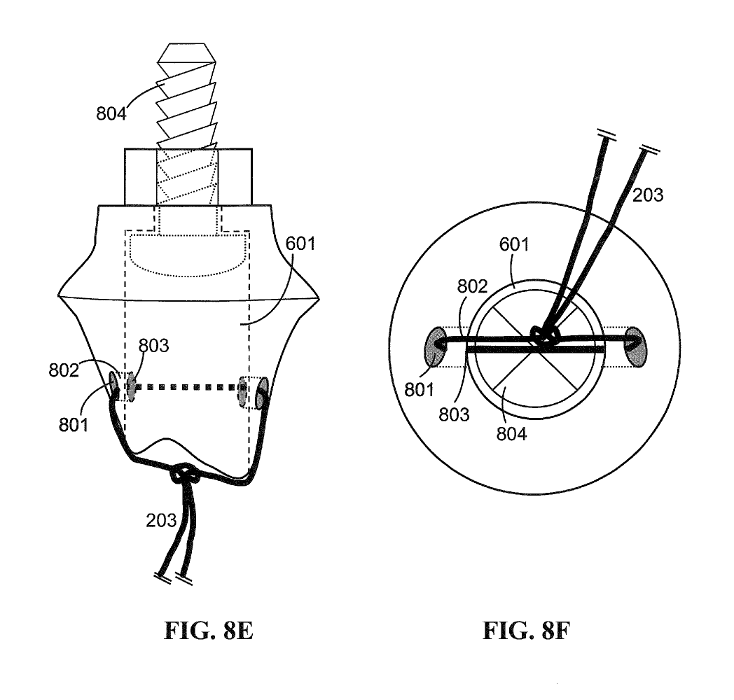

According to another embodiment, such as shown in FIGS. 8A and 8B, a tunnel 802 may also be positioned radially through the final abutment whereby one hole 801 is located on the perimeter or face of the abutment and the other hole 803 is located on the interior wall of the longitudinal hole 601.

According to yet another embodiment, such as shown in FIGS. 8C and 8D, two tunnels 802 can be provided where each tunnel 802 is positioned radially through the final abutment such that two holes 801 are located on the perimeter or face of the abutment and the other two holes 803 are located on the wall of the longitudinal hole 601. The two tunnels 802 can be considered to be a single tunnel that spans across the longitudinal hole 601 between the entry/exit holes 803 on the interior wall of the longitudinal hole 601 when lacing the floss through the tunnels 802.

The entry/exit holes 701, 801 of embodiments of the invention are positioned away from the proximal surface (i.e. the surface adjacent another tooth), thereby avoiding obstruction of the access to the entry/exit holes by the surrounding teeth (either natural or prosthetic).

As described with respect to the embodiments illustrated in FIGS. 2A-2C and 4A-4D, the entry/exit holes of the embodiments illustrated in FIGS. 7A-7B and 8A-8E are not limited in shape as circular (as illustrated herein). Furthermore, the diameter of the tunnel may be a different diameter than the interior portion of the tunnel.

FIGS. 8E and 8F illustrate a system for performing insertion and removal of a dental abutment in accordance with one embodiment of the invention. As shown in FIGS. 8E and 8F, a floss tether 203 can be tied tightly across the longitudinal hole 601. Not only does the floss enable better control of the abutment by the dentist when handling the abutment, but the use of the floss across the hole 601 can protect the loss of the screw 804 (see also screw 505 of FIG. 5). For example, when a final abutment is used on an implant located in the maxilla (and the abutment is inverted such as shown in FIG. 8E) the taut floss thereby serves to inhibit the abutment screw 804 from falling out of the final abutment before it has been fully attached to implant 500. An abutment screw which falls free from the dentist's control presents the same dangers to the patient as a fallen abutment (i.e., asphyxiation, aspiration, or digestive complication). Although a final abutment is shown in FIGS. 8D and 8E, this technique of knotting the tether is applied to healing abutments.

The final abutment with tunnel as described herein may be fabricated by a variety of means, including cast or milled. The tunnel may be formed at the same time or in a similar fashion as the healing abutment. The tunnel may also be added after fabrication by modifying a previously fabricated final abutment.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. In addition, any elements or limitations of any invention or embodiment thereof disclosed herein can be combined with any and/or all other elements or limitations (individually or in any combination) or any other invention or embodiment thereof disclosed herein, and all such combinations are contemplated with the scope of the invention without limitation thereto.

It should be understood that the examples and embodiments described herein are for illustrative purposes only and that various modifications or changes in light thereof will be suggested to persons skilled in the art and are to be included within the spirit and purview of this application.

1. A healing abutment comprising:
a post configured to secure the healing abutment to a dental implant;
a head on the post, the head having a face with a recess at a central region thereof, wherein the recess is configured to receive a tool employed in insertion or removal of the healing abutment; and
a tunnel within the head of the healing abutment configured to receive floss through the face of the head.

2-3. (canceled)

4. The healing abutment according to claim 1, wherein the healing abutment is configured for a dental surgery for implanting a root-form endosseous implant.

5. The healing abutment according to claim 1, wherein the tunnel is disposed through the healing abutment such that both an entry and an exit of the tunnel are positioned on the face of the abutment.

6. The healing abutment according to claim 1, wherein the tunnel is disposed through the healing abutment such that one of an entry and an exit of the tunnel is positioned on the face of the healing abutment and the other of the entry and the exit of the tunnel is positioned on an interior surface of the recess in the head of the healing abutment.

7. The healing abutment according to claim 6, further comprising a second tunnel disposed through the healing abutment such that one of an entry and an exit of the second tunnel is positioned on the face of the abutment and the other of the entry and the exit of the second tunnel is positioned on the interior surface of the recess in the head of the healing abutment, the tunnel and the second tunnel being configured for a single length of floss to be laced therethrough.

8. A method of controlling a healing abutment when inserting or removing the healing abutment, the method comprising:
lacing a length of floss through a tunnel of a healing abutment comprising a post configured to secure the healing abutment to a dental implant; a head on the post and having a face with a recess therein; and the tunnel disposed within the head of the healing abutment and configured to receive floss through the face of the head, the floss having a length such that excess length of floss is available after lacing the floss through the tunnel.

9. The method according to claim 8, further comprising after lacing the floss through the tunnel, tying or knotting the excess length of floss.

10. The method according to claim 8, wherein the tunnel is disposed through the healing abutment such that both an entry and an exit of the tunnel are positioned on the face of the healing abutment, the lacing of the floss comprising inserting the floss through the entry of the tunnel until a portion of the floss extends beyond the exit of the tunnel.

11. The method according to claim 8, wherein the tunnel is disposed through the healing abutment such that one of an entry and an exit of the tunnel is positioned on the face of the abutment and the other of the entry and the exit of the tunnel is positioned on an interior surface of the recess in the head of the healing abutment, the lacing of the floss comprising inserting the floss through the entry of the tunnel until a portion of the floss extends beyond the exit of the tunnel.

12. The method according to claim 11, wherein the healing abutment further comprises a second tunnel disposed through the healing abutment such that one of an entry and an exit of the second tunnel is positioned on the face of the healing abutment and the other of the entry and the exit of the second tunnel is positioned on the interior surface of the recess in the head of the healing abutment, the tunnel and the second tunnel being configured for a single length of floss to be laced therethrough, wherein the lacing of the floss comprises:
inserting the floss through the entry of the tunnel, the floss passing through the tunnel from the exit of the tunnel and being directed towards the entry of the second tunnel to pass through the second tunnel until a portion of the floss extends beyond the exit of the second tunnel.

13. A system for performing insertion and removal of a healing abutment, the system comprising:
a healing abutment comprising a post and a head, the head having a tunnel with an opening at a face of the head; and
a tether releasably attached via the tunnel.

14. The system according to claim 13, wherein the tether is dental floss laced through the tunnel of the healing abutment.

15. The system according to claim 13, wherein the tunnel is disposed through the head such that both an entry and an exit of the tunnel are positioned on the face of the head.

16. The system according to claim 13, wherein the tunnel is disposed through the head such that one of an entry and an exit of the tunnel is positioned on the face of the head and the other of the entry and the exit of the tunnel is positioned on an interior surface of a recessed portion in the head of the healing abutment.

17. The system according to claim 16, wherein the healing abutment further comprises a second tunnel disposed through the head such that one of an entry and an exit of the second tunnel is positioned on the face of the head and the other of the entry and the exit of the second tunnel is positioned on the interior surface of the recessed portion in the head of the abutment, the tunnel and the second tunnel being configured for the tether to be laced therethrough.

18. The healing abutment according to claim 1, wherein an exit and an entry hole of the tunnel face upwards on the head of the healing abutment.

19. The healing abutment according to claim 1, wherein at least one of an exit and an entry hole of the tunnel is disposed adjacent the recess on the face of the head.
